(19) United States
(12) Patent Application Publication
(10) Pub. No.: US 2025/0050253 A1
(43) Pub. Date: Feb. 13, 2025

(54) COMPONENT FOR A LIQUID FILTER

(71) Applicant: Robert Bosch GmbH, Stuttgart (DE)

(72) Inventors: Jose Luis Arias Arias, Madrid (ES); Ruben Alfaro Rodriguez, Getafe (ES); Jan Semet, Vordersteinenberg (DE); Ruben Schreiber, Ludwigsburg (DE)

(21) Appl. No.: 18/722,033

(22) PCT Filed: Dec. 19, 2022
(86) PCT No.: PCT/EP2022/086662

§ 371 Date: Aug. 19, 2024

(30) Foreign Application Priority Data
Dec. 20, 2021 (DE) 10 2021 214 658.9

(51) Int. Cl. B01D 35/30

(52) U.S. Cl. CPC B01D 35/30; B01D 2201/291; B01D 2201/347

(57) ABSTRACT

The invention relates to a component for a liquid filter (30) which has a housing (31), said component (100) having:—a cover (32) for installing on the housing (31);—a filter element (1) comprising—first end cap (2) facing the cover (32),—a second end cap (3) facing away from the cover (32), and—a filter medium (4) which is arranged between the first end cap (2) and the second end cap (3) along an axial direction (A) and which comprises a hollow interior (5); and—an elastically reversible compensation element (8); wherein the cover (32) has a cover lower face (42) facing the first end cap (2), and the first end cap (2) has an upper face (24) facing the cover (32). The cover (32), the filter element (1), and the compensation element (8) are captively coupled together.

### BACKGROUND

The invention relates to a component for a liquid filter comprising a housing. The invention also relates to a liquid filter comprising such a component.

Filter elements and liquid filters that are configured to filter a liquid are known from the prior art. For example, such liquid filters or filter elements are liquid filters or filter elements for filtering a urea solution that are used in SCR systems (“selective catalytic reduction”) for exhaust gas purification. Such liquid filters or filter elements are also known as DENOX filters or filter elements for DENOX filters. In order to prevent damage to a housing of the liquid filter at low temperatures, for example well below the freezing point of water, due to liquid freezing inside it and the resulting ice pressure, a so-called compensation element is often provided in such liquid filters or in such filter elements. This compensation element is inserted into the interior of a filter element arranged in the liquid filter, for example. The filter element usually has a first end cap, a second end cap and a filter medium with a hollow interior. The filter medium is arranged along an axial direction between the first end cap and the second end cap. The compensation element, which is made of an elastic material and/or comprises, e.g., a hollow interior is inserted into the interior of the filter element through an insertion opening which is, e.g., arranged in one of the two end caps when the filter element or the liquid filter is installed.

Especially in the case of filters for aqueous solutions, freezing can occur at relatively high temperatures compared to the gelling of diesel fuel or gasoline. Furthermore, filters for SCR systems are often installed in exposed areas of a vehicle, making it particularly easy for cold to attack them. In particular, the cover of such a (DENOX) liquid filter can be directly exposed to an external environment in which the air can move convectively or even the airstream can attack the cover and in this way the cover represents a constant heat sink at low temperatures. Such covers are usually made of plastic or metal and therefore also feature a relatively high temperature coefficient which is, e.g., approximately 0.23 W/K*m for PA66 (glass fiber-filled polyamide). In conventional filters for aqueous solutions, the liquid on the raw face or on the clean face of the filter element usually reaches an exterior on the cover side of the filter element, which is located between a housing cover and a first end cap of the filter element. In this way, the liquid comes particularly close to the outside of the liquid filter or even in direct contact with the cover. Or it is only separated by a thin solid layer, for example a wall of the compensation element, from an inner wall of the cover or a support element held by the cover, which is in contact with the outer environment of the liquid filter and thus represents a heat sink via convection, whereby the material of the compensation element, e.g. rubber, also has a fairly high temperature coefficient (rubber, e.g. approximately 0.16 W/K*m) and the material thickness is also quite thin for cost reasons and in order not to impair the deformability.

In the case of liquid filters, a so-called internal seal within a liquid filter, which prevents a fluidic short circuit between a clean face and a raw face of the filter element, must also be ensured. At the same time, so-called external sealing must also be ensured, which prevents leakage of liquid from the inside of the liquid filter into an external environment of the liquid filter. It is known from the prior art that the internal and/or external sealing is effected by sealing elements which are arranged on the cover of the filter housing and/or which effect the sealing as an axial seal by interacting with the cover of the filter housing. In the latter case, the seal is created by axially compressing a sealant (i.e., compressing the sealant along the axial direction that results, for example, from the installation direction of a filter element in the housing) between the cover and a corresponding counter-element of the filter element or the filter housing with the sealant interposed.

In order to put such a liquid filter into an operational state or to assemble or install it, the compensation element is often inserted into the filter element first. The filter element is then inserted into the housing of the liquid filter together with the preassembled compensation element and the housing is then closed by the cover. During disassembly, e.g. for maintenance purposes or to replace the filter element, the cover is first removed from the housing. The compensation element is then pulled out of the filter element. In a final step, a frequently rod-shaped disassembly tool is then inserted into the filter element (e.g. through openings in the first and second end caps of the filter element) and the filter element is pulled out of the housing using the disassembly tool.

DE 10 2012 223 028 A1 discloses such a liquid filter comprising a filter element and a compensation element, which is inserted into an interior of a filter element. Both the internal sealing and the external sealing take place along the axial direction. For the external seal, an elastically reversible protective cover, which acts as a compensation element, is clamped in a sealing area between the cover and the rest of the housing along the axial direction. It is further provided that, during normal operation of the liquid filter, the fluid system pressure ensures that liquid from an interior of the filter element passes through an opening in an end cap of the filter element and is only separated from an external environment of the liquid filter by a second area of the protective cover.

DE 10 2016 005 659 A1 discloses another liquid filter comprising a compensation element that projects into an interior of a filter element. The internal sealing is achieved by applying a force acting in the axial direction through the cover onto the filter element with an intermediate layer of sealant. The external sealing is performed by a circumferential seal on the outside of the cover. It is further provided that liquid from the interior of the filter element will reach the cover of the liquid filter, and that liquid from the outer face of the filter element will also reach the lower face of the cover facing the filter element. The core idea behind the present application is to allow freezing of the liquid located in the interior of the liquid filter as quickly and evenly as possible on the outer wall of the compensation element at very low outside temperatures, for which reason the best possible connection between the hollow interior of the compensation element and the cold ambient air of the outside environment of the liquid filter is provided.

### SUMMARY

It has been shown that the disassembly of a filter element, e.g. for maintenance purposes (e.g. after one to three years or when a certain differential pressure is reached), is time-consuming due to the number of steps to be performed and that various tools are required. Furthermore, it has been shown that the correct installation of the new filter element to be inserted is complicated and error-prone due to the various steps described hereinabove.

It has also been shown that in some cases the inside of the filter medium of the new filter is contaminated.

This is often due to the fact that, when inserting a new compensation element or even the previously used compensation element into the new filter element, an installer reaches into the inside of the filter element with their finger, for example through the opening opposite the insertion opening for the compensation element. If, for example, the compensation element is pushed into the interior of the filter medium through a first opening in the first end cap, installers often try to align the compensation element better in the interior. This is done by the installer using one or more fingers to reach into the interior through a second opening in the first end cap provided in the second end cap and then aligning or otherwise manipulating the free end of the compensation element there. If the installer's fingers or gloves are dirty and/or oily from previous work, this dirt will get onto the inside of the filter medium in the interior.

Even if an installer does not reach into the interior of the filter element with a finger, such soiling or contamination can occur. Compensation elements deposited in dirty environments or touching the new compensation element to be inserted with dirty fingers or gloves can lead to dirt, grime or lubricants getting onto the outer face of the compensation element and this soiled compensation element being inserted into the interior of the filter element.

The clean face of the filter element is often located there. The contamination can detach from the compensation element and/or be transferred to the filter medium. The contamination can thus reach downstream components in an undesirable way. Furthermore, such soiling may hinder homogeneous heat distribution when heating the liquid in the interior, as a result of which the amount of heating energy required to defrost the liquid or keep it liquid must be increased in an undesirable manner. The service life of the filter element and/or the compensation element may be reduced as a result.

Finally, for correct internal and/or external sealing of the liquid filter in the presence of axially acting sealing sections, it may be necessary to fasten the cover to the housing, e.g. at a very tightly tolerated torque. This requirement is not always known to untrained installers when replacing the filter element or cannot be reliably complied with.

It has also been shown that the correct installation of the compensation element in the interior can be problematic for untrained installers, which can lead to problems with internal and/or external sealing as well as problems if ice pressure occurs.

It may also happen that an installer will insert the previously used compensation element located in the replaced filter element into the new filter element, therefore omitting the installation of a new, unused compensation element. As a result, the risk of the reused compensation element suffering a leak and losing its ability to protect the housing against ice pressure is increased. There may also be an internal fluidic short circuit between the clean face and the raw face.

It has also been shown that the production of end caps for such filter elements is complex. These end caps are manufactured from plastic using injection molding, for example. If they now comprise a first opening that is located approximately centrally in the end cap, it may be necessary to provide multiple injection points in the injection molding process in order to prevent the end cap from being distorted or bent. Particularly in the case of plastics filled with glass fibers with a unidirectional alignment of the glass fibers, a warping of the end caps can occur when manufacturing such end caps using a single injection point. An injection mold comprising multiple injection points, on the other hand, is comparatively more complex and cost-intensive than one comprising just a single injection point.

There may therefore be a need to simplify the disassembly of the filter element and the compensation element and the reinstallation of the filter element and the compensation element, e.g. for maintenance purposes, to make it more cost-effective and to reduce the risk of incorrect installation. Furthermore, there may (simultaneously) be a need to prevent contamination of an outer face of the compensation element and/or an inner face or the interior of the filter element or the filter medium, even during maintenance work under ambient conditions that are not very clean, in order to avoid inhomogeneities in the heat distribution during heating and to prevent contamination from being discharged into downstream components. Furthermore, there may (simultaneously) be a need to prevent individual components of the liquid filter from being forgotten during maintenance work. Furthermore, there may (simultaneously) be a need to prevent the use of previously used, worn and/or unsafe components when changing or replacing the filter element. Furthermore, there may (simultaneously) be a need to minimize the amount of energy required to thaw liquid in the liquid filter or to keep it liquid, e.g. by means of a heater arranged on and/or in the liquid filter. Finally, there may (simultaneously) be a need to provide an end cap for such filter elements that is easy and inexpensive to manufacture and has a low risk of warping or distortion after the manufacturing process. Furthermore, there may (simultaneously) be a need to provide a filter element that enables a high volume flow during operation.

In the context of the present application, the term “comprise” should be understood as being synonymous with the term “include”, unless otherwise described.

Proposed according to a first aspect of the invention is a component for a liquid filter comprising a housing. The component can be configured for installation in or on the liquid filter or in or on the housing. The liquid filter can, e.g., be a DENOX filter or DENOX liquid filter.

The component comprises a cover for installation on the housing and a filter element and a compensation element. The cover, the filter element, and the compensation element are captively coupled together. This captive coupling of cover, filter element, and compensation element is in particular present before the component is installed in or on the housing of the liquid filter.

The filter element comprises a first end cap facing the cover and a second end cap facing away from the cover, as well as a filter medium, in particular for filtering liquid. The filter medium is arranged along an axial direction between the first end cap and the second end cap and has a hollow interior. The compensation element is designed to be elastically reversible. The cover comprises a lower face of the cover which faces the first end cap. The first end cap comprises an upper face which faces the cover.

As a result, the three elements-cover, filter element, and compensation element—can in an advantageous manner be handled as a single integral unit in the shape of the component. Both the installation and disassembly of the filter element in and out of the housing are considerably simplified thereby.

By means of the captive coupling of the three elements, only the cover need to be removed for disassembly, e.g. by unscrewing the cover. Due to the captive coupling, the compensation element and the filter element are automatically removed from the housing when the cover is removed. This also enables cleaner disassembly because the cover is generally not contaminated by the liquid present in the housing and an machine-like does not come into contact with the liquid when disassembling the component, e.g. by removing or unscrewing the cover, and thus also the filter element.

Installation is also considerably simplified because the compensation element need not first be correctly installed on or in the filter element or on or in the housing. The filter element must then be correctly inserted into the housing before the cover also has to be screwed on as a separate element, without tilting and at the correct torque. Instead, the entire component is advantageously inserted into the housing comprising the filter element first and then connected to the housing by means of the cover. Preassembly of the component, e.g. at the component manufacturer, enables high quality through quality control before installation in the housing and/or before delivery of the component. Handling of the component or its subcomponents by an installer is therefore no longer necessary. An installer therefore only has to install the component as a unit in or on the housing. Further advantageously, the result is preventing or making it more difficult for individual components (e.g., the filter element and/or the compensation element) to be intentionally or unintentionally forgotten during assembly after maintenance, as a result of which the liquid filter can no longer fulfill its function correctly. It is also prevented or made it more difficult to reuse a previously used compensation element. It also prevents or makes it more difficult to attach a new or used compensation element to an unsuitable other filter element and then insert it into the interior of the housing.

Further advantageously, contamination of the new compensation element and/or the interior of the filter medium is prevented. This is true because the preinstallation or preassembly and the captive coupling of the three elements—cover, compensation element, and filter element —means that it is no longer necessary for an installer (e.g., with dirty, oily, and/or damp fingers or gloves) to touch the compensation element and/or the filter element individually as parts and install them in their respective intended positions. Instead, the installer can simply hold the component by the cover and then handle the component. In this way, the installer can insert the component into the housing, e.g. by only holding it by the cover, thus avoiding contact with sections or partial elements of the component to be arranged in the housing interior (e.g., filter element, compensation element).

Advantageously, the result is increasing the energy efficiency of heating because there are no inhomogeneities in the heat distribution caused by contamination. Advantageously, the result is increasing the service life of the filter element and/or the compensation element (less heating energy, no contamination) and reducing waste. Further advantageously, the result is improving the CO2 balance and making the component more sustainable. Finally, the advantageous result is reducing the risk of downstream components of a liquid filter (e.g., pumps, exhaust gas aftertreatment systems, etc.) coming into contact with contaminants.

Finally, the captive coupling of the cover, filter element and compensation element also ensures correct positioning of the filter element and the compensation element without additional aids (such as springs for pressing the filter element against the cover, stops on which the filter element comes to rest, etc.), e.g. the axial position of the filter element within the housing interior. As a result, components can be conserved, and/or the housing of the liquid filter in which the component is used can be designed more simply.

The first end cap can, e.g., comprise a first opening. The compensation element can, e.g., be arranged in the interior of the filter element. It can, for example, protrude at least partially into the interior through the exemplary first opening. For example, it can be inserted into the interior through the first opening.

A radial direction R extends perpendicular to the axial direction A. A circumferential direction U is circumferential about the axial direction A.

The liquid filter for which the component is provided can comprise a heater or heating element, e.g. on and/or in the housing.

In one embodiment, it is provided that the cover, the filter element, and the compensation element are separate elements, whereby the coupling of the cover, filter element, and compensation element is designed to be force-locking, and/or frictional, and/or interlocking.

The separate presence of the elements has the advantage that, for example, for each of the elements (cover, filter element, compensation element), those materials and/or manufacturing processes can be selected which are particularly proven, cost-effective and safe for this element. Depending on the intended use or filter housing, different covers, filter elements and/or compensation elements can be coupled to form a specific component. Depending on the intended use, the component can therefore be advantageously formed from a modular, and therefore cost-effective, system of individual components.

The force-locking, and/or frictional, and/or interlocking connection of the elements to the component advantageously enables simple and cost-effective installation or assembly of the elements to form the component. The elements forming the component (cover, filter element, compensation element) can merely be clamped together, screwed together, clipped together, pressed together, etc. to form the component.

It is understood that, before the elements (cover, filter element, compensation element) are assembled into one component, each of these three elements can be present as an independent element separate from the other two elements. In principle, it is also possible for, e.g., two of the three elements to be present or designed as integral parts prior to installation, e.g. through the manufacturing process itself or through a prefabrication that is performed in advance in order to, e.g., form a bonded connection, e.g. by gluing, welding, etc.

In one embodiment, it is provided that the first end cap is attached to the cover such that it cannot be detached without causing damage.

Advantageously, manipulation of the component is made more difficult or hindered in an advantageous manner. For example, it is not easily possible (without damage) to simply replace the compensation element in or on the component with an old, previously used compensation element. Therefore, a user can feel quite confident that the quality of an original component provided has not been impaired by tampering.

For example, it can be provided that the first end cap features a clearance relative to the cover in the axial direction and/or in a circumferential direction about the axial direction.

As a result, compensation for tolerances is advantageously enabled in order to, e.g., reduce mechanical stresses in the component, such as in the event of varying material expansions due to rising or falling temperatures or vibration loads. This increases the safety of the component and its service life in an advantageous manner. In addition, the assembly of the component from the elements (cover, filter element, compensation element) can be simplified because each of the elements can feature production-related dimensional tolerances.

The clearance can, e.g., be between 0.1 mm and 3 mm along the axial direction. The clearance can, e.g., be between 0.1° and 5° along the circumferential direction. In principle, clearance along the radial direction is also conceivable. This clearance can, e.g., be between 0.1 mm and 3 mm.

Alternatively or additionally, it can be provided that the compensation element is retained in a clamped manner between the cover and the first end cap.

In this case, clamping can, e.g., be provided along the axial direction and/or along the radial direction.

As a result, the compensation element is fixed in its relative position in an advantageous manner, particularly easily, and securely with respect to the cover and/or filter element. Depending on the design of the clamp, the advantageous result is creating an internal seal between the clean face and the raw face such that an additional sealant for internal sealing can be omitted.

In one embodiment, it is provided that the compensation element has (at least one) latching lug on its outer face, whereby the compensation element comprises (at least one) radial section which is at a distance from the latching lug in the axial direction and extends radially outwards, whereby the compensation element is held in the first opening by means of the latching lug and the radial section. The latching lug can, e.g., be designed to be circumferential about the compensation element. However, the latching lug can also be designed to be circumferential only in sections on the outer face of the compensation element such that only a single latching lug or multiple latching lugs is present. In the same way, the radial section can, e.g., be circumferential about the compensation element in a circumferential loop. However, it can also be designed in sections such that only a single radial section or multiple radial sections are present. The compensation element can be retained by means of a latching lug and radial section in the form of, e.g., an insertion such that the compensation element is inserted into the first opening by means of the latching lug and the radial section. The retention can, e.g., be achieved, by an edge of the first opening coming to rest between the latching lug(s) and radial section(s) as viewed along the axial direction and being held in this way by the latching lug(s) and radial section(s), which act as undercuts. For example, it can be provided that the axial spacing of the latching lug and the radial section has an extension which is in a range between 80% and 120% of a thickness of the first opening at its edge, which is arranged between the latching lug and the radial section. In this way, the edge of the first opening can be clamped between the latching lug and the radial section. However, a certain clearance can be provided along the axial direction in order to absorb or compensate for thermal stresses or tensions caused by the effect of ice pressure on the compensation element. It can be provided that the thickened section is arranged between the latching lug and the radial section when viewed in the axial direction.

Due to the (at least one) latching lug, the compensation element can be easily, safely and reliably installed in or on the filter element or coupled to it in an advantageous manner, thereby making the component particularly safe and cost-effective to manufacture. Such a coupling can already represent a captive coupling between the filter element and the compensation element such that further coupling with the cover is, e.g., easy and simple because the compensation element is already preassembled on or in the filter element or coupled to it. Further advantageously, an installer can easily recognize when the installation has been successful by receiving haptic feedback (the inserted compensation element locks into place at the edge of the first opening and cannot be easily pulled out). In this way, the sealing of the compensation element to the first opening is also designed to be secure and reliable. Further advantageously, the compensation element retained in the first opening in this captive manner (so that it cannot easily slip out of the first opening and thus lose its sealing effect) when the component is, e.g., installed overhead in or on the housing of the liquid filter.

The compensation element can, e.g., have a body comprising a wall projecting into the interior, whereby the wall comprises a thickened section with a thickening in the region of the first opening. The seal between the compensation element and the first opening can, e.g., be formed in the thickened section. Advantageously, this enables a particularly good coupling between the compensation element and the filter element or between the compensation element and the cover. Further advantageously, an effective and reliable seal is provided as a result.

The thickening of the wall can, e.g., be formed both inwards and outwards in the thickened section when viewed in a radial direction. As a result, the coupling between the compensation element, the filter element and the cover is improved by, e.g., a tighter press fit.

Such a thickening can, e.g., be at least 1 mm, preferably at least 2 mm. This thickening can, e.g., represent a thickening compared to the average wall thickness of the wall. As a result, a secure coupling is achieved, even given production-related dimensional tolerances in the cover, compensation element, and/or filter element. As a result, the seal is improved in an advantageous manner.

The thickened section can, e.g., be arranged between the latching lug and the radial section when viewed in the axial direction. As a result, particularly reliable coupling of the filter element (or its first end cap) and the compensation element is ensured. The sealing is also improved.

In one embodiment, it is provided that in a state of the filter element installed in the housing, the compensation element is clamped between the first opening and a collar element projecting from the cover into the first opening when viewed in the radial direction.

As a result, a particularly simple, secure, and permanent coupling between the filter element, the compensation element, and cover are provided when forming the component. At least the compensation element can, e.g., as a result also be fixed in terms of its axial position relative to the filter element.

Further advantageously, the first opening is sealed on the inside or on the inside of the first opening. A radial sealing effect is achieved in a simple manner, which is independent of the axial pressure or axial force of the cover. In this way, a greater sealing distance can be advantageously achieved. Further advantageously, the pressure of the liquid acting in the axial direction can in this way be redirected in the radial direction, which results in less pressure load on the cover. Further advantageously, the sealing effect can in this way already be achieved and tested when the compensation element is installed on or in the filter element because it is not dependent on an axial position and/or axial pressure of the cover on the compensation element acting as a seal. In this way, the sealing effect of the component or in the component can also be advantageously checked after the compensation element has been installed and the risk of leakage due to, for example, an incorrectly installed cover (e.g., too little torque applied to the cover) is advantageously completely eliminated in this way. In other words, the correct replacement of filter elements, e.g. during maintenance work, is made easier and more reliable. The clamping by the collar element primarily prevents the sealing section between the compensation element (or its outer face) and the edge of the first opening from loosening.

In one embodiment, an end cap element projecting in the axial direction towards the cover is provided on the first end cap. The end cap element can, e.g., be designed as a first connecting piece. In a state designed as a component, the compensation element is thus clamped between the end cap element and a collar element projecting from the cover into the first opening when viewed in the radial direction. The end cap element in this case comprises the first opening or, when viewed from the outside, the first opening is associated with the end cap element.

The same advantages arise as above for clamping the compensation element between the first opening and the collar element. Furthermore, the end cap element can advantageously create a greater distance between the end cap (or its upper face) and the cover (or its lower face), which improves thermal insulation from the outside environment. As a result, the component designed in this way makes a beneficial contribution to saving energy. This thermal insulation enables lower temperature fluctuations and/or temperature gradients at the seals (sealant or compensation element) for external and/or internal sealing. Further advantageously, heating energy can be used more efficiently to thaw frozen or gelled liquid or to maintain the liquid phase, thereby saving energy. Furthermore, the end cap element can also be used to produce simplified filter elements from the same second end cap and the same filter medium if the housing for various liquid filters has a different length. Only the first end cap and the end cap element need to be adapted. It is therefore possible to adapt the length with little effort, which reduces part costs in an advantageous manner.

In one embodiment, it is provided that the cover comprises a latching structure, whereby the first end cap comprises a counter-latching structure complementary to the latching structure, whereby the cover and the first end cap are captively coupled to one another by interaction of the latching structure with the counter-latching structure.

As a result, a particularly simple coupling between the cover and the filter element is achieved in an advantageous manner. Further advantageously, the cover and the filter element or the first end cap of the filter element can be manufactured particularly easily. Advantageously, the latching structure and counter-latching structure can also be used for a modular concept, e.g. by using the same counter-latching structures for different filter elements, all of which can then be used with the cover and its latching structure for coupling. In the same way, the same latching structure can always be arranged on different covers such that different covers can be captively coupled to the same filter element or its first end cap. In this way, costs can be saved by using identical parts.

The latching structure and counter-latching structure can, e.g., interact with each other in the manner of a clip connection.

A pair consisting of a latching structure and a counter-latching structure can, e.g., be designed such that a latching hook or a latching protrusion or a latching lug is provided on the cover as a latching structure. For example, an undercut or a recess or a window can be arranged on the first end cap as a counter-latching structure, whereby, for example, the latching hook, etc. of the cover locks into the undercut or the window, etc.

If the cover is made of a stiffer material (e.g., PA66, PA6, PPA, PBT, or the like) than the first end cap, which for example comprises polypropylene, then it can be provided that the latching structure (e.g., a latching hook) is essentially not moved or tilted or displaced in the radial direction during latching, for example, and that the counter-latching structure (e.g., a window on the first end cap) is deflected radially, for example, during the latching process. This deflection can preferably be elastically reversible.

It is also possible that the latching structure on the cover be designed as an undercut, a recess, or as a window, etc. The counter-latching structure on the first end cap can, e.g., then be designed as a latching hook, latching protrusion, latching lug, etc.

It is understood that exactly one latching structure or counter-latching structure can be arranged on the cover and first end cap. However, a plurality of latching structures can also be arranged on the cover and/or a plurality of counter-latching structures can be arranged on the first end cap. For example, two pairs of latching structure and counter-latching structure are arranged on the cover and first end cap, e.g. on opposite sides (e.g., offset by approximately 180° to each other in the peripheral direction). Preferably, three or more pairs of latching structure and counter-latching structure can also be arranged on the cover and first end cap. In this way, the coupling between the cover and the filter element can continue to be stable, for example if a latching structure and/or a counter-latching structure is damaged. A kind of redundancy for the coupling is created in this way. An equidistant arrangement (along the circumferential direction) of the pairs of the latching structure and the counter-latching structure enables an even distribution of the mechanical forces. A non-equidistant distribution of the pairs of latching structure and counter-latching structure can facilitate correct orientation between the cover and filter element during installation of the component because the cover and filter element can, e.g., only be latched or coupled together in one or two positions.

The design of the latching structure as a latching hook or latching protrusion or latching lug and the counter-latching structure as a recess or window or undercut can be advantageous, since in this way, for example, an injection mold for the first end cap can be realized more simply, e.g. only with slides, than if latching hooks are provided there, which must then be formed and demolded by rotating elements in the injection mold. As a result, the manufacture of the part or its components or elements can therefore be simplified.

In one embodiment, it is provided that the latching structure projects from the lower face of the cover parallel to the axial direction (e.g., against the axial direction) towards the first end cap. As a result, the diameter of the cover is not increased in order to effect the coupling in an advantageous manner. Further advantageously, a gap can in this way be created between the lower face of the cover and the first end cap, which, e.g., provides thermal insulation that can save heating energy.

Alternatively or additionally, it can be provided that the lower face of the cover comprises an outer collar projecting parallel to the axial direction (e.g., opposite the axial direction) from it towards the first end cap comprising the latching structure.

The design of the outer collar provides mechanical stabilization of the latching structure because forces acting on the latching structure can be transferred to the entire collar. In this way, the coupling between the cover and filter element is particularly secure, stable, and reliable.

For example, the outer collar can, in an advantageous manner, make it more difficult to disengage the latching structure and counter-latching structure because it restricts, impedes or prevents a tool from penetrating from the outside to the latching point.

For example, a protrusion pointing radially inwards or radially outwards can be formed on the outer collar as a latching structure. Multiple latching structures can also be formed on the outer collar. It can also be provided that the cover comprises two, three, four, five, six, or even more outer collars, which are designed to be adjacent to each other in the circumferential direction, but are, e.g., separated from each other by slots.

Alternatively or additionally, it can be provided that the counter-latching structure protrudes from the upper face of the first end cap parallel to the axial direction (e.g., along the axial direction) towards the cover. Advantageously, the result is that the diameter of the first end cap will not be increased in order to effect the coupling. Further advantageously, a gap can in this way be created between the lower face of the cover and the first end cap, which provides thermal insulation that can, e.g., save heating energy.

In one embodiment, it is provided that the latching structure and the counter-latching structure are designed such that, when mechanical force is exerted in a direction from radially outwards to radially inwards on the structure that lies radially further outwards, the latching is reinforced.

Advantageously, the result is that the latch cannot be disengaged easily, only with difficulty, or not at all (radially outwards). As a result, the preassembled component is protected against the manipulation and replacement of its components. For example, if an installer wants to reuse the previously used compensation element when replacing the filter element, they cannot remove the new compensation element from the new component and replace it with the old compensation element. It is also not easy to remove the old compensation element from the removed component. Further advantageously, contamination of the compensation element of the component and the filter element with dirt and grime is also avoided in this manner.

If, for example, the latching structure is located farther outward in the coupled state, it should be understood that, when a tool is used to attempt to disengage, this tool will first hit the latching structure. If, on the other hand, the counter-latching structure in the coupled state is radially further out than the latching structure that is locked to it, such a tool will hit the counter-latching structure first.

It can, for example, be provided that a latching hook is the radially outward structure, and a window or recess, etc. is the radially inward structure. In this case, the tip of the hook can, e.g., point inwards. If a mechanical force acting radially inwards is then exerted on the latching hook from the outside, the latching hook is pressed more firmly into the recess and the latching action is not released, but reinforced.

If, for example, in another exemplary embodiment, a latching hook is arranged radially further inwards than the complementary recess, the complementary window, etc., and its hook tip is directed radially outwards, for example, the recess or the window can be closed radially outwards such that a tool cannot press through the wall of the window onto the tip of the latching hook and thus unlatch it. Pressure on the closed recess wall therefore reinforces the latching action.

For example, it can be provided that the radially inner structure is shielded against direct mechanical contact from the radially outer face by an outer face of the first end cap and/or by the radially outer structure (selected from the latching structure and counter-latching structure). As a result, it is advantageously even more difficult to manipulate the latching point. As a result, it is more difficult for dirt and grime to penetrate to the latching point.

In one embodiment, it is provided that the lower face of the cover comprises a coupling structure, whereby the upper face of the first end cap comprises a counter-coupling structure, whereby the coupling structure and the counter-coupling structure are coupled to one another such that a torque acting on the cover is transmitted from the cover to the filter element by means of the coupling of the coupling structure and the counter-coupling structure.

As a result, a separation of functions between the transmission of torques and the captive coupling is enabled between the cover, the filter element, and compensation element. This is true because the coupling structure enables the torque to be transmitted to the filter element or its first end cap, for example, when screwing in or unscrewing the cover on a cover that can be screwed to the housing without, e.g., loading a pairing of latching structure and counter-latching structure. Such structures (latching structure/counter-latching structure) can then be designed specifically for captive coupling and, for example, primarily for the transmission of axial forces. The requirement to transmit torque when screwing in the cover would require such structures to be unnecessarily enlarged, thus taking up space where space is at a premium. Further advantageously, the coupling structure and the counter-coupling structure can, e.g., prevent a compensation element clamped between the cover and the filter element from being stretched, pulled, or even torn. Furthermore, the installation process of the component in the housing of a liquid filter can be facilitated by transmitting the torque, and thus the rotation, of the cover to the filter element. This is true because, conventionally, a filter element is simply inserted into the housing by applying axial force along the axial direction. If sealing structures are arranged on the filter element, this is often associated with a high level of force, and there is a risk that the sealing structures will warp. A lubricant is therefore often used in conventional filters when installing the filter element. Via torque transmission, the component, and thus also the filter element, are inserted into the housing in a rotating manner, advancing only slowly along the axial direction. A sealant provided on the filter element therefore does not warp into itself so easily, and no or very little lubricant is required when installing the component. Disassembly is also performed more gently, and the risk of the filter medium tearing due to excessive axial forces when pulling the filter element out of the housing is reduced. A rotating disassembly also counteracts jerky, tilted removal. The rotation of the cover in the thread transforms the rotation into a uniform and always axially acting pull-out force. Overall, this (transmission of the torque from the cover to the filter element) provides a particularly simple installation process when installing the component in the housing, which also ensures the quality of the installation and also provides a particularly simple and gentle disassembly process.

It is understood that the coupling structure and the counter-coupling structure, for example, only interact loosely with each other. In other words, they need not be captively or permanently coupled (e.g., by a clip connection). In this context, the focus is on torque coupling.

The torque acting on the cover can, for example, be transmitted for the most part (more than 50%, preferably more than 75% and particularly preferably more than 90%) from the coupling structure to the counter-coupling structure. As a result, other components (e.g., latching structure, counter-latching structure, compensation element) are greatly relieved mechanically when the cover rotates.

The counter-coupling structure can, for example, be connected by means of a structural rib to an end cap element (or to the end cap element) projecting radially further inwards from the upper face, or to the upper face alone. In this way, the counter-coupling structure is particularly stabilized and secured for the transmission of higher torques.

The torque considered in this case acts in particular along the peripheral direction, which is circumferential about the axial direction.

For example, it can be provided that the cover comprises a protrusion or recess on the lower face of the cover and that the filter element comprises a complementary recess or protrusion on its upper face. For example, protrusion engages in the complementary recess such that a torque acting on the cover around the axial direction is transmitted from the cover to the filter element, in particular for the most part, by means of the coupling of the protrusion and complementary recess. Preferably, the protrusion and complementary recess can extend along the radial direction.

It is understood that exactly one coupling structure and exactly one counter-coupling structure can be provided. However, a plurality of coupling structures and counter-coupling structures can also be provided, thus reducing the torque applied to each pairing and provides redundancy in the event that a pairing ceases to function, e.g. due to damage.

In one embodiment, it is provided that the counter-coupling structure is designed such that, when the filter element and cover are coupled, the counter-coupling structure comes into mechanical contact with the lower face of the cover and/or the coupling structure comes into mechanical contact with the upper face of the first end cap before the counter-latching structure comes into contact with the lower face of the cover and/or before the latching structure comes into contact with the upper face of the first end cap, thus preventing in particular a further axial displacement of the cover and filter element towards each other.

Alternatively or additionally, it can be provided that the coupling structure is designed such that, when the filter element and cover are coupled, the counter-coupling structure comes into mechanical contact with the lower face of the cover and/or the coupling structure comes into mechanical contact with the upper face of the first end cap before the counter-latching structure comes into contact with the lower face of the cover and/or before the latching structure comes into contact with the upper face of the first end cap, thus preventing in particular a further axial displacement of the cover and filter element towards each other.

Both alternative or simultaneous designs have the advantage that an installer can recognize by touch when the cover and filter element are in the correct axial position relative to each other when assembling the component comprising the cover, filter element, and compensation element. Further advantageously, the result is ensuring that the coupling structure and counter-coupling structure are always securely coupled to each other such that torque is always transmitted via the coupling structure and counter-coupling structure and other components are not exposed to the torque. Further advantageously, the latching connection is in this way also protected against mechanical overload, which could occur if the cover is pressed too far onto the filter element along the axial direction. The latching structure and/or counter-latching structure can therefore be made more delicate and take up less space.

A kind of axial stopper effect is therefore created.

In one embodiment, it is provided that the second end cap comprises a second opening for liquid to flow through, whereby a grip guard is arranged in the second opening, which is configured to prevent a finger from penetrating into the interior through the second opening.

Advantageously, the result is further reducing the risk of contamination of components of the component. This is true because the grip guard initially prevents contamination of the inside of the filter medium when the compensation element is installed in the interior during assembly of the component, e.g. by an installer. Furthermore, during subsequent handling of the fully assembled component, e.g. shortly before installation in the housing, an installer is prevented from reaching into the interior of the filter medium of the preassembled component. Advantageously, the result is that the thawing process of liquid in the interior progresses in a non-uniform manner because contaminated areas lead to inhomogeneities in the heat flow. Furthermore, contamination is advantageously prevented from reaching the clean face of the filter medium. Further advantageously, the grip guard reduces the available volume for liquid in the filter element, or reduces the available volume for liquid in the housing of the liquid filter in which the filter element can be arranged. As a result, less heating energy is required when thawing frozen liquids or keeping liquids liquid at low outside temperatures. Advantageously, this enables a smaller heating element and also reduces fuel consumption (small CO2 footprint). Further advantageously, the volume of the compensation element can also be reduced due to the volume taken up by the grip guard, thereby also reducing the size of the compensation element. Advantageously, the result is a reduction in the amount of material used, thus making production more cost-effective. This is true because the size or volume of the compensation element is typically adapted to the volume of liquid in the filter element; this volume is reduced by the grip guard.

The second opening has, e.g., a diameter of at least 1.5 cm, preferably at least 2 cm. For example, the diameter is in the range between 1.5 cm and 7 cm, preferably in a range between 1.8 cm and 3 cm. The diameter can, e.g., be 2.3 cm.

The grip guard can, purely by way of example, be formed by a plurality of ribs. For example, the ribs extend outwards in the radial direction from a star point within the second opening. For example, they can be connected to an inner wall of the second opening. For example, the maximum distance between adjacent ribs is at most 1 cm, preferably at most 0.75 cm. For example, the distance is 0.85 cm. The ribs can, e.g., feature an angle in the range between 5° and 45°, preferably between 10° and 30°, with respect to the radial direction. For example, the angle is between 23 degrees and 26 degrees, e.g. 24.5 degrees.

The proposed diameters, distances, and angles reduce the risk of a finger or part of a finger reaching the inside of the filter medium even if the grip guard is partially overcome. The clean face of the filter element is often located on the inside of the filter medium. The angle can also enable a longer design for the compensation element. The second opening can, for example, also be located in a second connecting piece, which is arranged around the second opening of the second end cap. Such a second nozzle can, for example, protrude at least 0.5 cm, preferably at least 1 cm and most preferably at least 1.5 cm from the second end cap 3, e.g. in the range from 1.5 cm to 2.5 cm, for example 1.5 cm. As a result, the grip guard is further heightened in an advantageous manner because the distance from the front of the second nozzle to the inside of the filter medium is increased. Further advantageously, the compensation element can be designed to be longer, thus providing a larger compensation volume.

The design of a star point, from which ribs extend radially outwards, can also advantageously result in a simpler and more cost-effective production of the second end cap, and thus of the filter element. This is true because, if said end cap is produced in an injection molding process, e.g. from a glass fiber-filled plastic, a single injection point (e.g., in the star point or one of the ribs) can be sufficient to produce a low-distortion second end cap. This is otherwise not easily possible using an end cap with a second opening of a certain size without a star point and/or ribs. Multiple injection points are otherwise required in this case. For example, the second end cap can be made of plastic.

It can, for example, comprise or be made of unfilled polypropylene (PP) or polyamide (PA) or hard polyethylene (HDPE (abbreviation for “high density polyethylene”)) or comprise or be made of a glass fiber-filled plastic, e.g. PE, PA (e.g., PA66), HDPE, etc. These can in this case be thermoplastics and/or thermosetting plastics. The compensation element can, for example, comprise ethylene propylene diene rubber (EPDM) or hydrogenated acrylonitrile butadiene rubber (HNBR), e.g. for the most part or be made thereof. The cover and/or a housing of the liquid filter can, e.g., be made of PA, PA6, PA66, polyphthalamide (PPA) or be made of these materials (with or without glass fiber filling).

In one embodiment, it is provided that the first end cap comprises a circumferentially outward sealant, whereby the compensation element projects from a cover-side exterior of the filter element through the first opening into the interior and seals the interior in a fluidically sealed manner against the passage of liquid from the interior into the cover-side exterior through the first opening, whereby the sealant is configured to seal a filter outer volume located between a housing wall, an outer face of the filter medium and a lower face of the first end cap facing the filter medium against the cover-side exterior in a state of the filter element installed in the housing.

Advantageously, the result is that both the external seal and the internal seal in the cover-side area of the filter element are created solely by the filter element or by sealant arranged on the filter element, and direct cooperation from the cover is not required. As a unit, the component therefore provides the internal seal and the external seal.

In other words, even the component loosely installed in the housing (not completely screwed down) could be safely operated in this way without liquid from the inside of the housing getting into an external environment of the liquid filter and without a fluidic short circuit occurring between the raw face and the clean face. The cover is therefore advantageously only required to securely and permanently fix the component in the housing.

If the cover is, e.g., screwed to the housing up to a stop, then the external and internal seals will be automatically formed correctly. The component in the form of a module which is installed on the housing by means of the cover enables simple and safe maintenance of the liquid filter. It is no longer necessary to pay attention to exact torques during installation.

Therefore, the cover as such need not be involved in the fluidic sealing of the liquid being filtered, whereby a further seal is not excluded as a redundancy of the external seal. In addition to the fixing effect of the filter element in the housing, it also acts as protection against the ingress of dirt, grime, or liquids, e.g. splash water from the outside environment, into the housing. The filter element of the component designed in this way is therefore autonomous with regard to the sealing effect. As a result, it particularly easy to perform a quality check with respect to the sealing effect, even during preassembly of just the filter element. Separate preassembly of sealants on the cover and/or quality testing of such a seal can be omitted. As a result, the manufacturing process is more cost-effective. Further advantageously, the installation of the filter element is simplified during maintenance because an installer need only check the filter element and its sealant (e.g., after the filter element has been manufactured and thus before it is coupled to the cover) and need not additionally check a sealant arranged on the cover. Further advantageously, it is not necessary to maintain a very precise torque or axial force on the cover when installing the cover. Further advantageously, it is in this way ensured that the sealant for external sealing (on the first end cap) and also the internal sealing by means of the compensation element are arranged at a clear distance from the external environment and are therefore not directly exposed to strong temperature fluctuations and that the temperature gradient in the sealant or along the sealing section can also be lower than would be the case with an installation closer to the cap.

Furthermore advantageously, it is ensured that no liquid is present between an upper face of the first end cap facing the cover and the cover. The direct transfer of cold from the cover to the liquid and also to the sealant is prevented in this way. In other words, the liquid is advantageously at a greater distance from the cover, which acts as a heat sink. The liquid is also advantageously separated from the cover for the most part, at least by the first end cap. Advantageously, the result is reducing cooling of the liquid or heat loss from the liquid to the outside environment. The component therefore provides thermal insulation of the interior of the housing from the outside environment. Advantageously, the result is that the liquid in the filter element or the liquid in the filter outer volume located below the first end cap only freezes after a longer period of time than in a situation in which the liquid is located in the cover-side exterior. It also takes longer for crystallization points which initiate the freezing process to form in the liquid. Further advantageously, the energy required to thaw or prevent a liquid in the filter element from freezing is also reduced. This is true because the energy used no longer has to be used to heat the liquid in direct or indirect contact with the cover against the cold acting inwards from the cover or to dissipate valuable thermal energy to the heat sink of the cover or the outside environment. In other words, a type of thermal insulation is created that prevents a thermal bridge from an external environment of the filter element or the liquid filter directly into the liquid-filled cover-side exterior.

The sealing of the cover-side exterior by means of the compensation element and the sealant can, for example, be designed such that the cover is not in direct contact with the liquid at any point. Advantageously, the result is that the liquid does not freeze as quickly when the cover is exposed to low temperatures that are below the freezing point of the liquid. A direct thermal bridge and the formation of crystallization nuclei for ice formation are prevented. Further advantageously, the heating energy supplied to the liquid is used much more effectively to thaw the liquid and/or keep it liquid. Therefore, the same volume of liquid or frozen liquid can be thawed or kept liquid with less energy input. Further advantageously, the temperature fluctuations at the external and/or internal seal are minimized, thus extending the service life of the sealant and/or compensation element.

In one embodiment, it is provided that the sealant is set up for sealing along the radial direction, whereby the sealing of the first opening by the compensation element is designed as a seal along the radial direction. Advantageously, the result is that the sealing effect with regard to the external seal is created directly when the component, and thus the filter element, are installed in the housing, e.g. when the filter element is inserted into the housing. The sealing effect of the internal seal is already achieved when the component is assembled, during coupling between the compensation element and the filter element, and can already be checked for quality in this state. Advantageously, the cooperation of the cover is no longer be required for the sealing effect. In particular, it is not necessary for an installer to use precisely defined forces or torques to attach the cover to or in the housing, for example by screwing it in. Advantageously, installation errors, which could impair the filtration effect due to a fluidic short circuit between the raw face and the clean face or allow liquid to escape from the liquid filter into the outside environment, are avoided in this manner.

Proposed according to a second aspect of the invention is a liquid filter.

The liquid filter has a housing comprising a cover, a housing interior, as well as, in particular, an inlet and an outlet. The liquid filter also comprises a component as described hereinabove. In particular, the housing and the component are connected to each other. For example, the cover belonging to the component can be screwed to the housing.

As a result, a liquid filter that is easy to maintain, inexpensive to manufacture, has a low risk of contamination, is highly energy efficient, and reduces the risk of incorrect installation of serviced components is provided in an advantageous manner. Further advantages result from the foregoing description.

The liquid filter can, e.g., comprise a heater or heating element on or in the housing.

### BRIEF DESCRIPTION OF THE DRAWINGS

Further features and advantages of the present invention will become apparent to the skilled person with reference to the accompanying drawings and based on the following description of exemplary embodiments, which are not, however, to be interpreted as limiting the invention.

Shown are:

FIG. 1 a schematic longitudinal section through a liquid filter according to the prior art;

FIG. 2 a schematic longitudinal section through a liquid filter comprising a component for the liquid filter;

FIG. 3 a schematic longitudinal section through the compensation element and the cover of the liquid filter in FIG. 2;

FIG. 4 a schematic perspective exploded view of the component in FIG. 2;

FIG. 5 a schematic perspective, partially sectioned view of the component in FIG. 2;

FIG. 6 a schematic sectional view of a cover comprising a latching structure and a first end cap comprising a counter-latching structure;

FIGS. 7a, 7b a schematic perspective view of the lower face of a cover (FIG. 7a) and a schematic cross-section through this cover (FIG. 7b);

FIGS. 8a, 8b a schematic perspective view of an upper face of a first end cap (FIG. 8a) and a schematic cross-section through this first end cap (FIG. 8b);

FIG. 9a a schematic view of the lower face of the cover in FIGS. 7a and 7b;

FIG. 9b a schematic top view of the upper face of the first end cap shown in FIGS. 8a and 8b.

### DETAILED DESCRIPTION

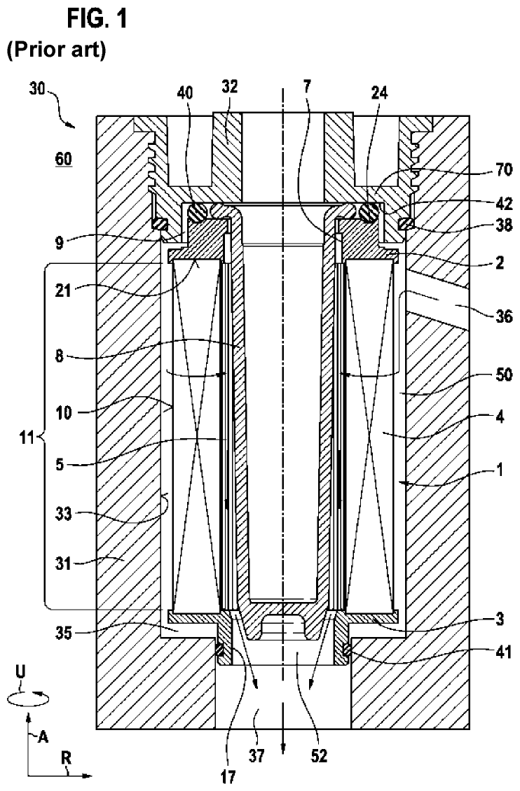

FIG. 1 shows a schematic longitudinal section through a liquid filter 30 from the prior art. The liquid filter 30 has a housing 31 comprising a cover 32. The housing 31 is in this case, by way of example, cup-shaped and comprises a housing interior 35. The housing further comprises an inlet 36 for unfiltered liquid, which is located in the liquid filter 30 on a raw face 50, and an outlet 37 for filtered liquid, which is located in the liquid filter 30 on a clean face 52. The liquid filter 30 also comprises a filter element 1 separate from the cover 32, whereby the filter element 1 is arranged in the housing interior 35. The filter element is installed parallel to an axial direction A (in this case against the axial direction A) in the housing interior 35, e.g. plugged in, or screwed in, or the like. The filter element 1 comprises a first end cap 2, which faces the cover 32 and comprises a first opening 7, as well as a second end cap 3 facing away from the cover 32. The filter element comprises a filter medium 4 comprising an interior 5, into which a compensation element 8 is inserted. An external seal is in this case provided by a circumferentially outward cover sealant 38 arranged on the cover 32, which sealant is pressed against a housing wall 33 of the housing 31. The external seal is in this case designed as an axial seal, whereby the sealing effect depends on an axial position, and thus an axially acting force of the cover 32. A so-called internal seal, which prevents a fluidic short circuit from the raw face 50 to the clean face 52 without passing through the filter medium 4, is in this case ensured by a first end cap sealant 40, which seals axially against the cover 32, and by a second end cap sealant 41, which is arranged on the second end cap 3 and seals it against the housing wall 33 of the housing 31.

It is clearly evident that the sealing effect of the first end cap sealant 40 is dependent on the contact pressure or the pressure of the cover 32 on the first end cap sealant 40. Furthermore, the first end cap sealant 40 is arranged very close to the outer environment 60 and is only separated from the outer environment 60 by the cover 32 or its base plate 70, with which it is in direct contact. The first end cap sealant 40 is therefore exposed to large temperature fluctuations and may also be exposed to very large temperature gradients. Similarly, the cover sealant 38 is also arranged close to the external environment 60 and is only separated from the external environment 60 by the cover 32 with which it is in contact. Therefore, the cover sealant 38 is also exposed to large temperature fluctuations and/or large temperature gradients.

Furthermore, it is clearly evident that the uncleaned liquid passes between the housing wall 33 of the housing 31 and an outer face of the first end cap 2 into an exterior 9 on the cover side and fills it, whereby the exterior 9 on the cover side is arranged between a lower face 42 of the cover 32 or the base plate 70 and an upper face 24 (or outer face) of the first end cap 2 facing the cover 32. Liquid or fluid therefore flows from a filter outer volume 11 into the exterior 9 on the cover side. The filter outer volume 11 is in this case regarded as the volume which is formed between the housing wall 33 or the inner wall of the housing 31, an outer face 10 of the filter medium 4 and a lower face 21 (or inner face) of the first end cap 2 facing the filter medium 4.

A radial direction R extends perpendicular to the axial direction A. A circumferential direction U is circumferential about the axial direction A.

In the context of this application, the term “comprises” should be understood as being synonymous with the term “includes”, unless otherwise described.

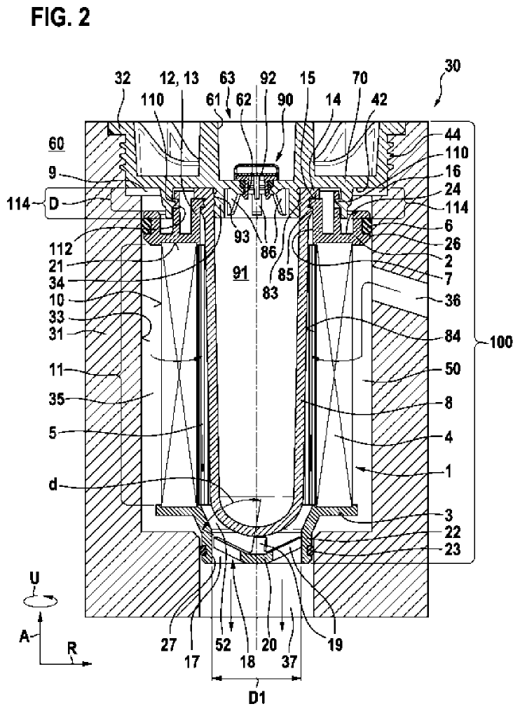

FIG. 2 shows a schematic longitudinal section through a liquid filter 30 comprising a component 100 for the liquid filter 30.

The liquid filter 30 has a housing 31 comprising a housing interior 35 as well as an inlet 36 and an outlet 37. The liquid filter also comprises a component 100.

The liquid filter 30 can further comprise a heater or at least one heating element, which is not shown herein for reasons of clarity. This heater or the heating element can be arranged in the housing interior 35 and/or outside the housing 31 and can be set up to keep the liquid in the liquid filter 30 liquid or to thaw it again from a frozen state.

The component 100 comprises a cover 32 for installation on the housing 31 as well as a filter element 1 and a compensation element 8. The housing 31 and the component 100 are (in this case by way of example) connected to each other. The cover 32, the filter element 1, and the compensation element 8 are captively coupled to each other. In particular, this captive coupling is already present before the component 100 is installed in the housing 31 such that the component 100 can be handled as a single unit for installing or mounting the component 100 in or on the housing 31 and, e.g., need only be gripped at the cover 32.

The filter element 1 comprises a first end cap 2 facing the cover 32 (in this case by way of example) comprising a centrally located first opening 7, and a second end cap 3 facing away from the cover 32, as well as a filter medium 4 arranged along an axial direction A between the first end cap 2 and the second end cap 3 with a hollow interior 5. The filter medium 4 is configured for filtering liquid. It can, for example, be made of filter paper, melt-blown, or the like. It can be star-folded, for example. In this case, by way of example, the liquid to be filtered flows through it radially outwards (raw face 50) to radially inwards (clean face 52).

The compensation element 8 is designed to be elastically reversible and is in this case, by way of example, arranged in the interior 5. The cover 32 comprises a cover lower face 42 facing the first end cap 2. The first end cap 2 comprises an upper face 24 facing the cover 32.

The cover 32 has a channel 63 comprising a first opening 61 which, when the cover 32 is installed on the housing 31, faces an external environment 60 of the liquid filter 30, and comprising a second opening 61 facing the compensation element 8 when the cover 32 is mounted on the housing 31, whereby the channel 63 is configured to enable gas exchange between the external environment 60 and the compensation element interior 91 when the cover 32 is installed on the housing 31.

In one embodiment (not shown in this case), the cover 32 can furthermore comprise at least one cavity sealed off from the external environment 60 and from the housing interior 35, at least when installed on the housing 31. In such a cavity, a cavity surface of the at least one cavity, in particular projected along the axial direction A, can amount to at least 30%, preferably at least 50%, of the surface of the cover 32 facing the housing interior 35. In this case, the lower face 42 of the cover facing the first end cap 2, e.g. including the surface of the channel 63, can be used as the reference surface. The cover 32 can comprise a single cavity or a plurality of cavities. The cavities can, for example, be predominantly filled with gas, e.g. air. The cavities can feature an average height along the axial direction A of at least 1 mm, preferably at least 3 mm. At least 25%, preferably at least 50%, of the complete peripheral area (i.e., the total area surrounding and thus forming the cavity) of the closed or pocket-like cavities can be formed by surfaces 43 of the cover 32. By way of example, the boundary surface can be made of a single material (the material for the cover 32).

The cover 32 comprises a thread 44 on its periphery, whereby the thread 44 is configured to screw the cover 32 to the housing 31.

If at least one cavity is provided, then the thread 44 (when viewed along the axial direction A) is preferably arranged between the housing interior 35 and the at least one cavity when the cover 32 is installed on the housing 31.

As is clearly evident, a cross-section of the narrowest point of the channel 63 of the cover 32 has at most 25% of the area of a compensation element opening 93 of the compensation element interior 91 facing the channel 63. The channel 63 can, for example, be designed to increase the time required for a convective exchange of the gas volume of the compensation element interior 91 with the external environment 60 by at least a factor of 10, compared to a compensation element interior directly connected to the external environment 60. The formation of a thermal bridge from the exterior 60 into the compensation element interior 91 is prevented in this manner.

Furthermore, it is clearly evident that a cap element 90 is arranged in or on the channel 63, whereby the cap element 90 is designed to prevent the penetration of dirt, grime, insects and/or moisture into the compensation element interior 91. The cap element 90 is in this case designed to, e.g., continue to enable gas exchange between the compensation element interior 91 and the external environment 60. In this case, the cap element comprises, by way of example, a membrane 92, through which a gas exchange between the compensation element interior 91 and the external environment 60 is enabled, whereby the membrane 92, however, prevents the penetration of moisture, as well as dirt and grime, into the compensation element interior 91. The cap element 90 itself can, for example, be inserted or clipped into the second channel opening 62. The cap element can protect the membrane 92 from damage by a cap. For example, it can be provided that a gas exchange rate or an air flow rate through the cap element 90 is in a range from 1 mL/min to 1000 mL/min, preferably from 10 mL/min to 1000 mL/min and particularly preferably from 50 mL/min to 600 mL/min, in particular at a differential pressure of 70 mbar.

In order to further slow down a convective air exchange from the compensation element interior 91 and the external environment 60, for example, a labyrinth seal or an interdigital structure can be provided at least in a section of the compensation element 8, in which protrusions project into the compensation element interior 91 from two or more inner faces, which are offset from each other along the axial direction such that a gas exchange with the external environment 60 is suppressed or slowed down. Other agents having an equivalent effect are also conceivable. Furthermore, it is conceivable that the compensation element 8 is made of a compressible material, e.g. a foam material, and/or is at least partially filled with it such that the compensation element interior 91 is at least partially filled with this material. In this way, a thermal bridge extending from the external environment 60 into the interior 5 of the filter element 1 is prevented because non-circulating air or air not subject to convection has a very low thermal conductivity of approximately 0.026 W/K*m.

The filter element 1 of the component 100 shown in this case has an exemplary design that enables simple installation and disassembly as well as secure sealing, efficient use of heating energy and a high level of protection against contamination when the component is installed in the housing 31 and also when the filter element 1 is coupled with the cover and compensation element 8 to the component 100.

The second end cap 3 of the filter element 1 in this case comprises, by way of example, a second opening 17 for the flow of liquid, whereby a grip guard 18 is arranged in the second opening 17, which is configured to prevent a finger from penetrating into the interior 5 through the second opening 17. The second opening 17 features, e.g., a diameter D1 of at least 1.5 cm, preferably at least 2 cm, e.g. a diameter D1 of 2.3 cm. The grip guard 18 in this case is, by way of example, formed by a plurality of ribs 19. In this case, the ribs 19 extend, by way of example, from a star point 20 inside the second opening 17 in a radial direction R outwards. In this case, the ribs are, by way of example, connected to an inner wall 27 of the second opening 17. A maximum distance d between adjacent ribs can, for example, be at most 1 cm, preferably at most 0.75 cm. The distance d is, e.g., 0.85 cm. The ribs 19 can be arranged with respect to the radial direction R at an angle in the range between 5° and 45°, preferably between 10° and 30°. For example, the angle is between 23 degrees and 26 degrees, e.g. 24.5 degrees. In this way, the introduction or entry of dirt on the inside of the filter medium 4, which can lead to inhomogeneities in the heat distribution in the interior and would therefore impair energy efficiency, is prevented in an advantageous manner. In addition to the at least one cavity 64 in the cover 32, this further improves the utilization of heating energy.

The first end cap 2 of the filter element 1 comprises a circumferentially outward sealant 6, whereby the compensation element 8 projects from a cover-side exterior 9 of the filter element 1 through the first opening 7 into the interior 5 and seals the interior 5 in a fluidically sealed manner against the passage of liquid from the interior 5 into the cover-side exterior 9 through the first opening 7. The sealant 6 is configured to seal a filter outer volume 11 located between a housing wall 33, an outer face 10 of the filter medium 4, and a lower face 21 of the first end cap 2 facing the filter medium 4 against the cover-side exterior 9 when the filter element 1 is installed in the housing 31 (as shown in FIG. 2). The sealing of the cover-side exterior 9 by means of the compensation element 8 and the sealant 6 is designed such that the cover 32 is not in direct contact with the liquid at any point. Furthermore, the sealant 6 is configured to seal along the radial direction R, whereby the sealing of the first opening 7 by the compensation element 8 is designed as a seal along the radial direction R.

The sealant 6 can, e.g., be designed as an O-ring or a sealing cord.

If a surface of the first end cap 2 without the first opening 7 is considered, then the sealant 6 and the sealing of the first opening 7 by means of the compensation element 8 ensure that at least 50% of this surface of the first end cap 2, preferably at least 70% of this surface, is at a distance from the cover 32 by a gap 16. This gap 16 is preferably filled with air in the specified surface area (at least 50% or at least 70%). It is particularly advantageous if the gap 16 is filled exclusively with air. In this way, the outflow of heat from the liquid filter in the direction of the cover 32 is advantageously further reduced, and energy efficiency during heating is further increased.

Viewed along the axial direction A, the gap 16 features an average thickness of at least 1 mm, preferably at least 2 mm. As a result, a particularly good thermal insulation is provided against the cold on the cover 32, and energy efficiency during heating is increased.

As a result, the component 100 feature a high level of sealing quality and high energy efficiency during heating, while at the same time being very simple and intuitive to install.

In this exemplary embodiment, the cover 32, the filter element 1, and the compensation element 8 are initially designed as separate elements. They are joined together or captively coupled to form component 100 by an interlocking coupling between the cover 32 and the filter element 1, an interlocking coupling between the compensation element 8 and the filter element 1, as well as a frictional connection of the compensation element 8 between the cover 32 and the filter element 1 or the first opening 7 thereof in the first end cap 2.

In principle, the coupling of cover 32, the filter element 1, and the compensation element 8 can, e.g., be force-locking, and/or frictional, and/or interlocking.

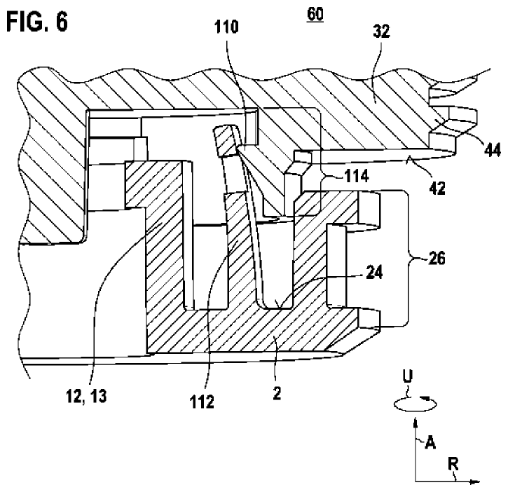

As is clearly evident in FIGS. 2 and 6, the filter element 1 and the cover 32 are not only captively coupled to each other. The coupling is even designed such that, after coupling, damage-free decoupling of the filter element 1 from the cover 32, and in this case also of the compensation element 8 retained in a clamped manner between the filter element 1 or first end cap 2 and cover 32, is not possible. Decoupling is therefore only possible if damage to the cover 32 or the filter element 1 or the compensation element 8 is accepted, risked, or achieved. As a result, the component 100 is protected against tampering, and users of the component 100 can be sure that the component 100 will function reliably as a replacement part for a used component 100.

In this case, the first end cap 2 is attached the cover 32 such that it cannot be detached without causing damage. In order to be able to reduce a mechanical stress between the elements of the component 100 in the event of vibrations or thermal expansion, it is provided in this case, by way of example, that the first end cap 2 features a clearance relative to the cover 32 in an axial direction A and/or in a circumferential direction U that is circumferential about the axial direction A.

Regarding the captive coupling between the cover 32 and the filter element 1, the cover 32 comprises a latching structure 110, which is in this case designed, by way of example, as a latching lug or as a latching hook comprising a hook tip or nose tip pointing radially inwards. The first end cap 2 comprises a counter-latching structure 112 complementary to the latching structure 110, in this case a window or a recess, into which the latching hook can engage. The cover 32 and the first end cap 2 are therefore captively coupled to one another by interaction of the latching structure 110 with the counter-latching structure 112. In the view in FIG. 2, two latching hooks are visible as latching structure 110 and two windows or recesses are evident as counter-latching structure 110. However, fewer or more latching structure 110 and counter-latching structure 112 pairs can also be provided, e.g. exactly only one pair, three pairs, four pairs, five pairs, six pairs, or even more pairs. Using two pairs, a good tilting protection is already achieved between the cover 32 and the filter element 1. Additional pairs can provide redundancy if, e.g., one of the pairs is damaged. In addition, the tamper resistance of the component 100 is increased by each additional pair that must be released from its coupling or latching position.

In this exemplary embodiment, the lower face 42 of the cover comprises an outer collar 114 projecting parallel to the axial direction A (in this case opposite the axial direction A) from the lower face 42 of the cover towards the first end cap 2 comprising the latching structure 110 (in this case the latching hooks or latching lugs). The counter-latching structure 112 in this case protrudes, by way of example, from the upper face 24 of the first end cap 2 parallel to the axial direction A (in this case along the axial direction A) towards the cover 32.

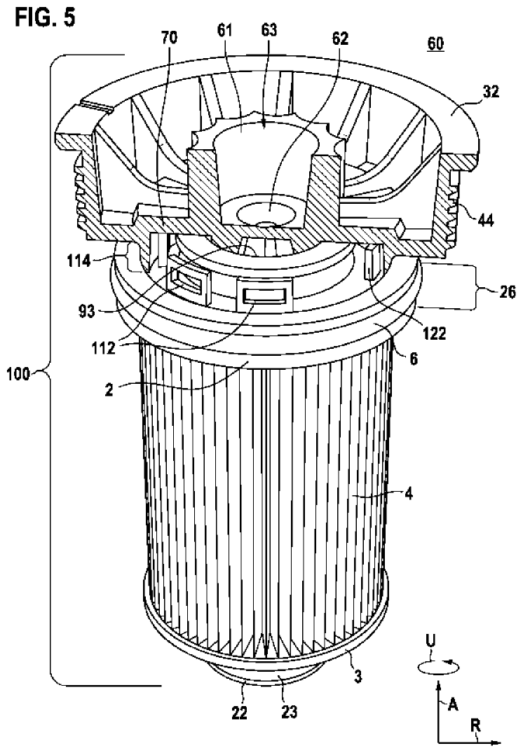

In this embodiment, the manipulation protection is further increased by the latching structure 110 and the counter-latching structure 112 being designed such that, when mechanical force is exerted in a direction from radially outwards to radially inwards on that structure 110, 112, which is located radially further outwards (in this case the latching hook or the latching lug, i.e. the latching structure 110), the latching is reinforced. An attempt to release the latch, for example by inserting a mandrel, screwdriver or similar tool from the outside into the slot between the lower face 42 of the cover and the upper face 24 of the first end cap 2, will therefore fail because the latch is reinforced (see also FIG. 5). The latching mechanism can then only be detached by damaging or destroying the latching structure 110 and/or the counter-latching structure 112, which requires a considerable amount of time and detailed knowledge.

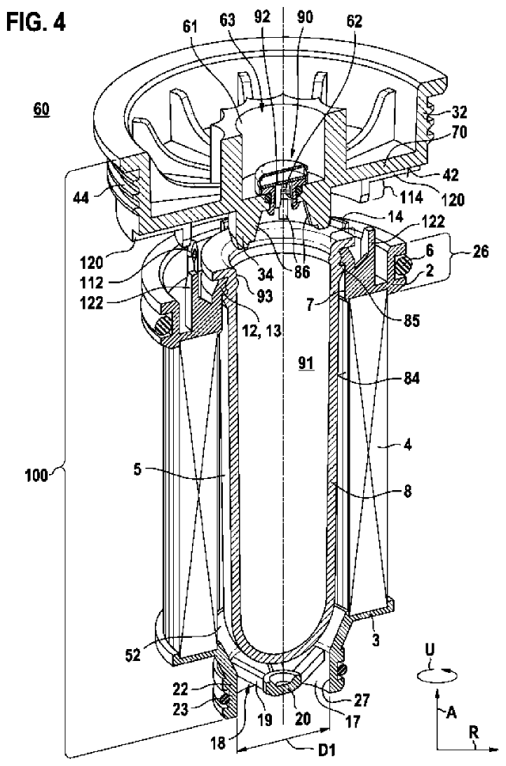

The tamper protection is further increased by the radially inner structure 110, 112 (in this case the counter-latching structure 112, the window, or the recess) being shielded against direct mechanical contact from the radially outer face by an outer face 26 (see also FIGS. 4 and 5) of the first end cap 2 and/or by the radially outer structure 110, 112 (in this case by the latching structure 110 or by the outer collar 114 comprising the latching structure 110). This also prevents or makes it more difficult to “reach around the corner” in order to release the latch.

It is understood that the latching lugs or latching hooks can also be arranged on the first end cap 2 (as a counter-latching structure 112), and the recesses or windows can be arranged as a latching structure 110 on the cover 32. Mixed designs are also possible (latching hooks and windows on the cover 32 as latching structures 110 and (complementary) windows and latching hooks on the first end cap 2 acting as the counter-latching structure 112).

In the embodiment shown in this case, the manufacture of the first end cap 2 is facilitated by the provision of the windows as a counter-latching structure 112, because it is in this case possible to work with slides in an injection mold, and no rotating parts need be used to form latching lugs and the subsequent demolding due to the tight space conditions.

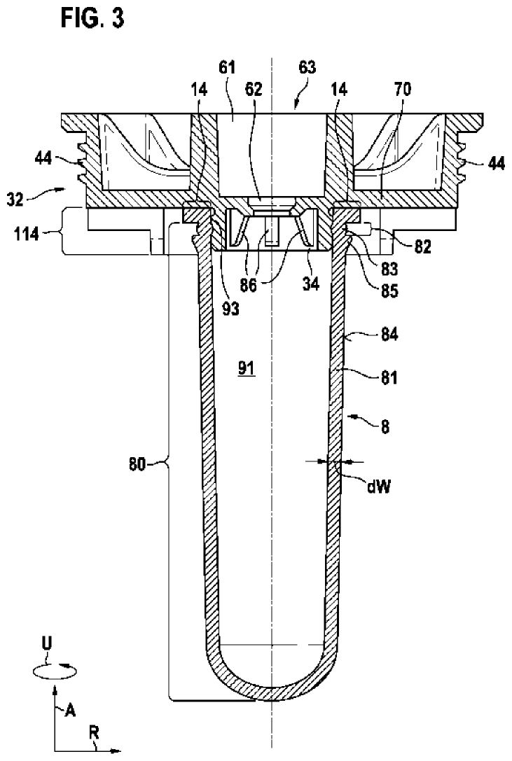

FIG. 3 shows a schematic longitudinal section through the compensation element 8 and the cover 32 of the liquid filter from FIG. 2.

The compensation element 8 has a body 80 comprising a wall 81 projecting into the interior 5 of the filter element 1 (see FIG. 2). In the area of the first opening 7 (see FIG. 2), the wall 81 has a thickened section 82 comprising a thickening 83. The seal between the compensation element 8 and the first opening 7 is in this case, by way of example, formed in the thickened section 82. The thickening 83 of the wall 81 in the thickened section 82 is formed both inwards and outwards when viewed in the radial direction. In this case, the thickening 83 can, e.g., be at least 1 mm, preferably at least 2 mm, in particular compared to the average wall thickness dW of the wall 81, which is shown (by way of example) in the lower part of the body 80.

The compensation element 8 comprises an (e.g., circumferential) latching lug 85 on its outer face 84. It also comprises, in this case by way of example, a radial section 14 at a distance from the latching lug 85 in the axial direction A, e.g. circumferentially, and which extends radially outwards. The compensation element 8 is retained in the first opening 7 by means of the latching lug 85 and the radial section 14 (in this case, by way of example, inserted; see FIGS. 2 and 4).

A captive coupling between the filter element 1 and the compensation element 8 is thus provided, even before clamping by the cover 32 when assembling the component 100 from its elements.

As previously described hereinabove in FIG. 2, the compensation element 8 is clamped between the first opening 7 and a collar element 34 projecting from the cover 32 into the first opening 7, when viewed in the radial direction R.

In principle, it is also conceivable that the compensation element 8 in the thickened section 82 comprises, in its compensation element interior 91, a reinforcing structure that penetrates through the compensation element interior 91, thus rendering the cooperation of the cover 32 unnecessary. For example, this element can be at least one, e.g. spoke-shaped, clamping rib, clamping ring, or the like, whereby these elements can assume the effect of the collar element 34. These elements can be (subsequently) inserted into the compensation element 8 or connected to it in one piece.

The collar element 34 projecting from the cover 32 in axial direction A comprises reinforcing ribs 86.

Formed on the first end cap 2 is an end cap element 12 projecting parallel to the axial direction A (in this case along the axial direction A) towards the cover 32, in this case by way of example in the form of a first socket 13, whereby the compensation element 8 is clamped between the end cap element 12 and the collar element 34 when viewed in the radial direction R.

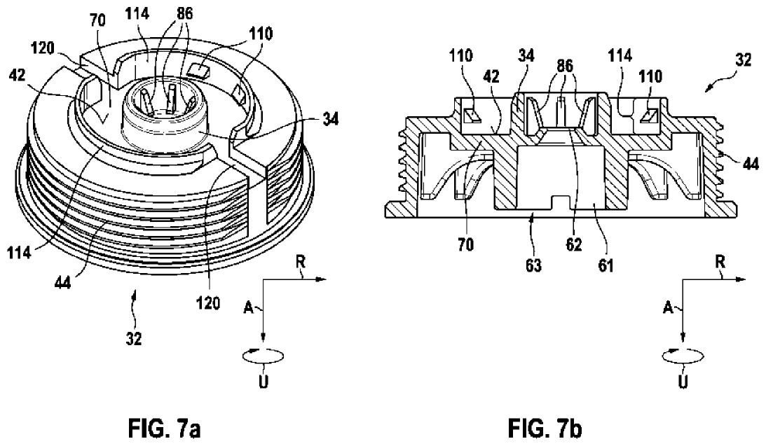

FIG. 4 shows a schematic perspective exploded view of the component 100 in FIG. 2. In this case, the component 100 is not yet installed in the housing 31. It is shown in a not yet captively coupled state. In order to finally assemble the component 100, the cover 32 must still be captively coupled to the filter element 1 (and the compensation element 8) in the view in FIG. 4. In FIG. 4, a coupling structure 120 on the cover 32 (approximately in the sectional plane, recognizable by the slight step on the lower face of the cover 42) and a counter-coupling structure 122 on the first end cap 2 were previously shown in section. These are explained in more detail in the description for FIGS. 7-9 and are used to transmit a torque of the cover 32 to the filter element 1 during installation or disassembly of the component 100 into the housing 31 or out of the housing 31.

FIG. 5 shows a schematic perspective, partially sectioned view of the component 100 from FIG. 2. In this case, the component 100 is already composed of the three elements of cover 32, compensation element 8, and filter element 1, and the three elements 1, 8, 32 are captively coupled together. It is clearly evident that the component 100 can be handled as a unit by simply grasping it by the cover 32. The filter element 1 is also fixedly defined with respect to its axial position relative to the cover 32 (with a certain clearance of, e.g., between 0.1 mm and 3 mm along the axial direction A and/or at a certain clearance along the peripheral direction, e.g. in a range between 0.1° and 5°). Additional components (e.g., springs or stops in the housing 31) can then be omitted in order to adjust the axial position of the filter element 1 in the housing 31 of the liquid filter 30 (see also FIG. 2). The counter-latching structures 112 protrude from the upper face 24 of the first end cap 2 in a clearly recognizable manner. Furthermore, a toothing can be seen on the outer face of the channel 63, which can be used to engage a tool in order to tighten the cover 32 on the housing 31 and thus connect the component 100 to the housing 31 or to place or install the filter element 1 in the housing 31. Due to the internal and external seal or gasket addressed hereinabove, which are each designed as radial seals and do not depend on the torque with which the cover 32 is screwed onto the housing 31, the cover 32 can simply be screwed in or screwed onto the housing 31 by an installer up to the thread stop or a seating of the edge of the cover on the housing 31. The functionality of the liquid filter is then guaranteed in this position.

FIG. 6 shows a schematic sectional view of a cover 32 comprising a latching structure 110 and a first end cap 2 comprising a counter-latching structure 112. It is evident that, in this exemplary embodiment, the latching hook or the latching lug of the latching structure 110 is not deflected radially during latching, but instead the counter-latching structure 112 in the form of a window or a recess is deflected radially inwards. As a result, tamper resistance can be improved because the radially outer latching structure 110 is very torsion-resistant. For example, a glass-fiber-filled plastic (e.g., PA66) can be used for the cover 32. The first end cap can be made of a softer or more elastic material (e.g., PP) so that the deflection of the counter-structure element 110 is facilitated. It is understood that, in other exemplary embodiments, the latching hook of the cover 32 can also be deflected.

The outer face 26 of the first end cap 2 and the counter-latching structure 112 form a kind of trench between them, into which the latching structure 110 or the outer collar 114 comprising the latching lug acting as a latching structure 110 dips. Therefore, manipulation of the established latching connection by force from the radial outside is virtually impossible (or only by accepting damage), since the outer collar 114 is very stable (rigid material) and can also be supported at its free end at the root of the counter-latching structure 112 when force is applied from the radial outside. Force applied further down along the axial direction A is in turn prevented by the raised outer face 26 of the first end cap 2, on which the sealant 6 (not shown in this case) can be arranged.

FIGS. 7a and 7b show a schematic perspective view of the lower face 42 of a cover 32 (FIG. 7a) and a schematic cross-section through this cover 32 (FIG. 7b).

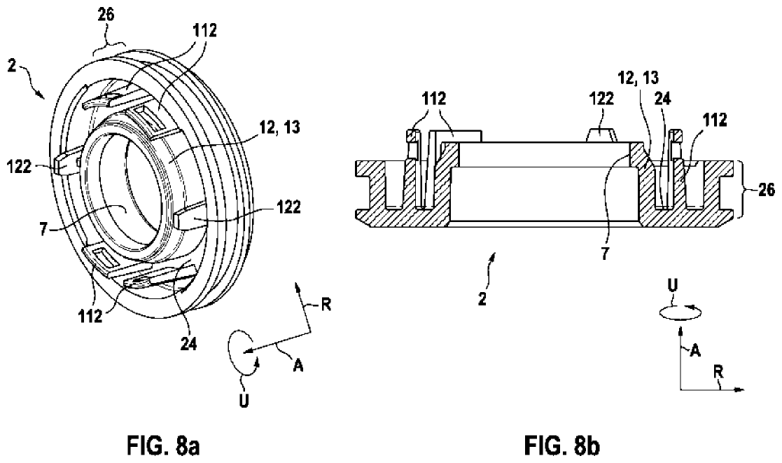

FIGS. 8a and 8b show a schematic perspective view of an upper face 24 of a first end cap 2 (FIG. 8a) and a schematic cross-section through this first end cap 2 (FIG. 8b).

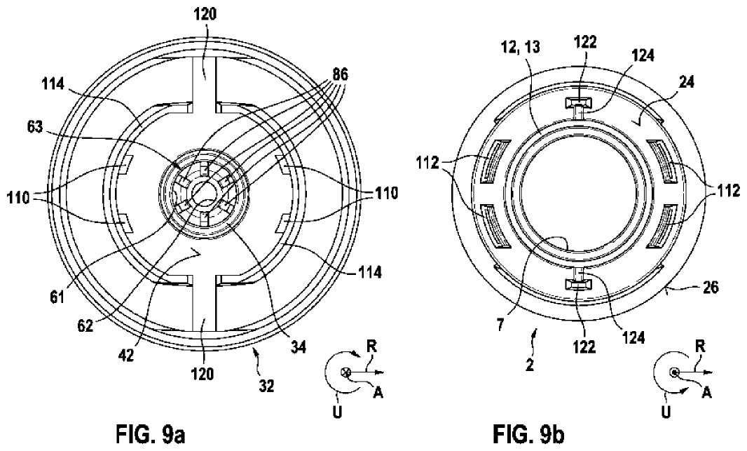

FIG. 9a shows a schematic top view of the lower face 42 of the cover 32 in FIGS. 7a and 7b.

FIG. 9b shows a schematic top view of the upper face 24 of the first end cap 2 in FIGS. 8a and 8b.

FIGS. 7a, 7b, 8a, 8b, 9a, and 9b are described together hereinafter.

FIGS. 7a, 7b and 9a show that the lower face of the cover 42 comprises a coupling structure 120. The latter is in this case designed in the form of two slots or recesses offset from each other by 180° along the peripheral direction U, each of which runs along the radial direction R. The slits or cut-outs are in this case led through the outer collar 114 such that the outer collar 114 is in this case designed as two partial collar pieces insulated from one another. Furthermore, two latching structures 110 in the form of radially inward-facing latching lugs or latching hooks are formed on each partial collar piece.

FIGS. 8a, 8b and 9b show that the upper face 24 of the first end cap 2 comprises a counter-coupling structure 122 in addition to four counter-latching structures 112 in the form of windows or recesses (complementary to the latching structures 110 of the cover 32). By way of example, two counter-coupling structures 122 are formed in this case. The latter protrude from the upper face 24 of the first end cap 2 in axial direction A and are designed such that they can engage in the coupling structures 120 of the cover 32.

The coupling structure 120 and the counter-coupling structure 122 are coupled to each other in the assembled or coupled state of component 100 such that a torque acting on cover 32 is transmitted, in particular for the most part (i.e., more than 50%), from cover 32 to filter element 1 by means of the coupling of coupling structure 120 and counter-coupling structure 122. In this way, the torque of the cover 32 can be transmitted to the filter element 1 without damaging the compensation element 8 clamped between the two elements and without the latching structures 110 or counter-latching structures 110 designed for the axial coupling being damaged by the torque or having to be designed to be so strong enough to also transmit torques. A separation of functions is advantageously achieved.

In FIGS. 8a and 9b, it is clearly evident that the counter-coupling structure 122 is in this case connected by means of a structural rib 124 to the end cap element 12 projecting radially further inwards from the upper face 24.

The counter-coupling structure 122 is in this case designed such that, when the filter element 1 and the cover 32 are coupled, the counter-coupling structure 122 comes into mechanical contact with the lower face 42 of the cover before the counter-latching structure 112 comes into contact with the lower face 42 of the cover and/or before the latching structure 110 comes into contact with the upper face 24 of the first end cap 2, thus preventing in particular a further axial displacement of the cover 32 and the filter element 1 towards each other. The counter-coupling structure in this case acts in the manner of an axial stopper. As a result, it can provide an installer with haptic feedback during assembly of the component as to when the latching between the cover 32 and the filter element 1 is or must be reliably established. At the same time, damage to the latching structure 110 and/or the counter-latching structure 112 (by, e.g., overpressing along the axial direction A) is prevented.

The liquid filter 30 can, e.g., be a DENOX liquid filter. Such a DENOX liquid filter can be used in an SCR system, for example, to filter aqueous urea solutions for exhaust gas aftertreatment systems.

1. A component for a liquid filter (30) which comprises a housing (31), said component (100) comprising:
a cover (32) for installation on the housing (31);
a filter element (1) comprising
a first end cap (2) facing the cover (32), which has a first opening (7),
a second end cap (3) facing away from the cover (32), and
a filter medium (4) arranged along an axial direction (A) between the first end cap (2) and the second end cap (3) with a hollow interior (5);
an elastically reversible compensation element (8), which is arranged in the interior (5);
wherein the cover (32) comprises a cover lower face (42) facing the first end cap (2),
wherein the first end cap (2) comprises an upper face (24) facing the cover (32),
wherein the cover (32), the filter element (1), and the compensation element (8) are captively coupled to one another.

2. The component according to claim 1, wherein the cover (32), the filter element (1), and the compensation element (8) are separate elements from one another, wherein the coupling of the cover (32), the filter element (1), and the compensation element (8) is configured to be force-locking, and/or frictional, and/or interlocking.

3. The component according to claim 1, wherein the first end cap (2) is attached to the cover (32) such that it cannot be detached without causing damage,
wherein the first end cap (2) features a clearance relative to the cover (32) in the axial direction (A) and/or in a circumferential direction (U) that is circumferential about the axial direction (A),
and/or
wherein the compensation element (8) is retained in a clamped manner between the cover (32) and the first end cap (2).

4. The component according to claim 1, wherein an outer face (84) of the compensation element (8) comprises a latching lug (85), wherein the compensation element (8) comprises a radial section (14), which is at a distance from the latching lug (85) in the axial direction (A) and extends radially outwards, wherein the compensation element (8) is retained in the first opening (7) by means of the latching lug (85) and the radial section (14).

5. The component according to claim 1, wherein the compensation element (8) is, when viewed in a radial direction (R), clamped between the first opening (7) and a collar element (34) that projects from the cover (32) and into the first opening (7).

6. The component according to claim 5, wherein an end cap element (12) projecting in the axial direction (A) towards the cover (32) is formed on the first end cap (2), wherein the compensation element (8) is clamped between the end cap element (12) and the collar element (34) when viewed in the radial direction (R).

7. The component according to claim 1,
wherein the cover (32) comprises a latching structure (110),
wherein the first end cap (2) comprises a counter-latching structure (112) complementary to the latching structure (110),
wherein the cover (32) and the first end cap (2) are captively coupled to each other by interaction between the latching structure (110) and the counter-latching structure (112).

8. The component according to claim 7,
wherein the latching structure (110) projects from the lower face (42) of the cover parallel to the axial direction (A) towards the first end cap (2),
and/or
wherein the lower face (42) of the cover comprises an outer collar (114), which projects from the latter towards the first end cap (2) parallel to the axial direction (A) and which comprises the latching structure (110),
and/or
wherein the counter-latching structure (112) projects from the upper face (24) of the first end cap (2) in the axial direction (A) towards the cover (32).

9. The component according to claim 7, wherein the latching structure (110) and the counter-latching structure (112) are configured such that, when mechanical force is exerted in a direction from radially outward to radially inward on the structure (110, 112), which is disposed farther radially outward, then the latching is reinforced, wherein the radially inside structure (110, 112) is shielded against direct mechanical contact from radially outward by an outer face (26) of the first end cap (2) and/or by the radially farther outward structure (110, 112).

10. The component according to claim 1, wherein the lower face (42) of the cover comprises a coupling structure (120), wherein the upper face (24) of the first end cap (2) comprises a counter-coupling structure (122),
wherein the coupling structure (120) and the counter-coupling structure (122) are coupled to one another such that a torque acting on the cover (32) is transmitted from the cover (32) to the filter element (1) by the coupling of the coupling structure (120) and the counter-coupling structure (122),
wherein the counter-coupling structure (122) is connected by a structural rib (124), to an end cap element (12) projecting radially farther inward from the upper face (24).

11. The component according to claim 7,
wherein the lower face (42) of the cover comprises a coupling structure (120), wherein the upper face (24) of the first end cap (2) comprises a counter-coupling structure (122).
wherein the coupling structure (120) and the counter-coupling structure (122) are coupled to one another such that a torque acting on the cover (32) is transmitted from the cover (32) to the filter element (1) by the coupling of the coupling structure (120) and the counter-coupling structure (122),
wherein the counter-coupling structure (122) is connected by a structural rib (124), to an end cap element (12) projecting radially farther inward from the upper face (24),
wherein the counter-coupling structure (122) is configured such that,
and/or
wherein the coupling structure (120) is configured such that,
when the filter element (1) and the cover (32) are coupled, the counter-coupling structure (122) comes into mechanical contact with the lower face (42) of the cover, and/or the coupling structure (120) comes into mechanical contact with the upper face (24) of the first end cap (2) before the counter-latching structure (112) comes into contact with the lower face (42) of the cover and/or before the latching structure (110) comes into contact with the upper face (24) of the first end cap (2), thus preventing a further axial displacement of the cover (32) and filter element (1) towards each other.

12. The component according to claim 1,
wherein the second end cap (3) comprises a second opening (17) for liquid to flow through,
wherein a grip guard (18) is arranged in the second opening (17), which grip guard is configured to prevent a finger from penetrating into the interior (5) through the second opening (17),
wherein the second opening (17) features a diameter (D1) of at least 1.5 cm,
wherein the grip guard (18) is formed by a plurality of ribs (19),
wherein the ribs (19) extend outwards in the radial direction (R), and
wherein a maximum distance (d) between adjacent ribs is at most 1 cm.

13. The component according to claim 1,
wherein the first end cap (2) comprises a circumferentially outward sealant (6),
wherein the compensation element (8) projects from a cover-side exterior (9) of the filter element (1) through the first opening (7) and into the interior (5) and seals the interior (5) in a fluidically sealed manner against a [the] passage of liquid from the interior (5) into the cover-side exterior (9) through the first opening (7),
wherein the sealant (6) is configured to seal a filter outer volume (11) located between a housing wall (33), an outer face (10) of the filter medium (4), and a lower face (21) of the first end cap (2) facing the filter medium (4) against the cover-side exterior (9) when the filter element (1) is installed in the housing (31),
wherein the sealing of the cover-side exterior (9) by the compensation element (8) and the sealant (6) is configured such that the cover (32) is not in direct contact with the liquid at any point.

14. The component according to claim 13, wherein the sealant (6) is configured for sealing along a radial direction (R), wherein the sealing of the first opening (7) by the compensation element (8) is configured as a seal along the radial direction®.

15. A liquid filter,
said liquid filter (30) comprising:
a housing (31) comprising a housing interior (35) and comprising an inlet (36) and an outlet (37),
a component (100) according to claim 1, wherein the housing (31) and the component (100) are connected to each other.

16. The component according to claim 1, wherein the component for a liquid filter (30) is for a DENOX filter.

17. The component according to claim 4, wherein the latching lug (85) is a circumferential latching lug (85), wherein the radial section (14) is a circumferential radial section (14), and wherein the compensation element (8) is buttoned in the first opening (7) by the circumferential latching lug (85) and the circumferential radial section (14).

18. The component according to claim 12, wherein the second opening (17) features a diameter (D1) of at least 2 cm,
wherein the ribs (19) start from a star point (20) within the second opening (17), extend outwards in the radial direction (R) and are connected to an inner wall (27) of the second opening (17), and
wherein a maximum distance (d) between adjacent ribs is at most 0.75 cm.

19. The component according to claim 6, wherein the end cap element (12) projecting in the axial direction (A) towards the cover (32) includes a first connecting piece (13).
